(19) United States
(12) Patent Application Publication
(10) Pub. No.: US 2023/0136956 A1
(43) Pub. Date: May 4, 2023

(54) Machine Learning System and Methods for Price List Determination From Free Text Data

(71) Applicant: Insurance Services Office, Inc., Jersey City, NJ (US)

(72) Inventors: Nicholas Sykes, American Fork, UT (US); Matthew Taylor, Lehi, UT (US); Kelly Redd, Orem, UT (US); Tyler Thalman, Spanish Fork, UT (US)

(73) Assignee: Insurance Services Office, Inc., Jersey City, NJ (US)

(21) Appl. No.: 17/976,271

(22) Filed: Oct. 28, 2022

Related U.S. Application Data
(60) Provisional application No. 63/273,874, filed on Oct. 29, 2021.

(51) Int. Cl. G06Q 40/08

(52) U.S. Cl. CPC G06Q 40/08

(57) ABSTRACT

Machine learning systems and methods for price list determination from free-form text data are provided. The system obtains a text description of an item, such as an item that is the subject of an insurance loss claim and processes the text description using a first machine learning model to identify an item being described by the text description. The system then processes the text description using a second machine learning model to identify one or more candidate matching items from a database. The system then automatically populates one or more user interface screens of a claims processing software application using the output of the first machine learning model and the output of the second machine learning model. The system electronically processes an insurance claim by the claims processing software application using the information automatically populated into the user interface, thereby greatly increasing the speed and accuracy with by which insurance claims data can be processed by the claims processing software application.

### RELATED APPLICATIONS

This application claims priority to U.S. Provisional Patent Application Ser. No. 63/273,874 filed on Oct. 29, 2021, the entire disclosure of which is hereby expressly incorporated by reference.

### BACKGROUND

### Technical Field

The present disclosure relates generally to the field of machine learning. More specifically, the present disclosure relates to machine learning systems and methods for price list determination from free-form text data.

### Related Art

In the insurance claims processing field, the ability to rapidly acquire information regarding an insurance claim is paramount. In particular, it is especially important to rapidly and accurately acquire information through the life cycle of an insurance claim, from first notice of loss (FNOL), collection of loss detail data, estimation of replacement items, and processing of payments to claim filers. Often, such information is manually captured by insurance adjusters, in a process that is time consuming and prone to errors.

There are currently computer-based insurance claims processing software applications utilized in the insurance industry. While such systems greatly assist with capturing and processing of relevant claims data, they require manual entry of claims data by users of such systems. Also, such systems require the user to manually parse claims data in order to determine one or more price lists for replacing lost equipment, materials, and objects. As a result, these systems are also susceptible to errors and require significant amounts of user time. This drawback is not limited to the insurance claims field, and indeed, many software systems which require manual data entry by users are subject to the same drawbacks as insurance claims processing software.

Accordingly, what would be desirable are machine learning systems and methods for price list determination from free-form text data, which addresses the foregoing and other needs.

### SUMMARY

The present disclosure relates to machine learning systems and methods for price list determination from free-form text data. The system obtains a text description of an item, such as an item that is the subject of an insurance loss claim. The system processes the text description using a first machine learning model to identify an item being described by the text description. The system then processes the text description using a second machine learning model to identify one or more candidate matching items from a database. The system then automatically populates one or more user interface screens of a claims processing software application using the output of the first machine learning model and the output of the second machine learning model. The system electronically processes an insurance claim by the claims processing software application using the information automatically populated into the user interface, thereby greatly increasing the speed and accuracy by which insurance claims data can be processed by the claims processing software application.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating steps in accordance with the present disclosure;

FIGS. 3-10 are screenshots illustrating various user interface screens generated by the system; and

FIG. 11 is a flowchart illustrating, in greater detail, processing steps carried out by the system of the present disclosure.

### DETAILED DESCRIPTION

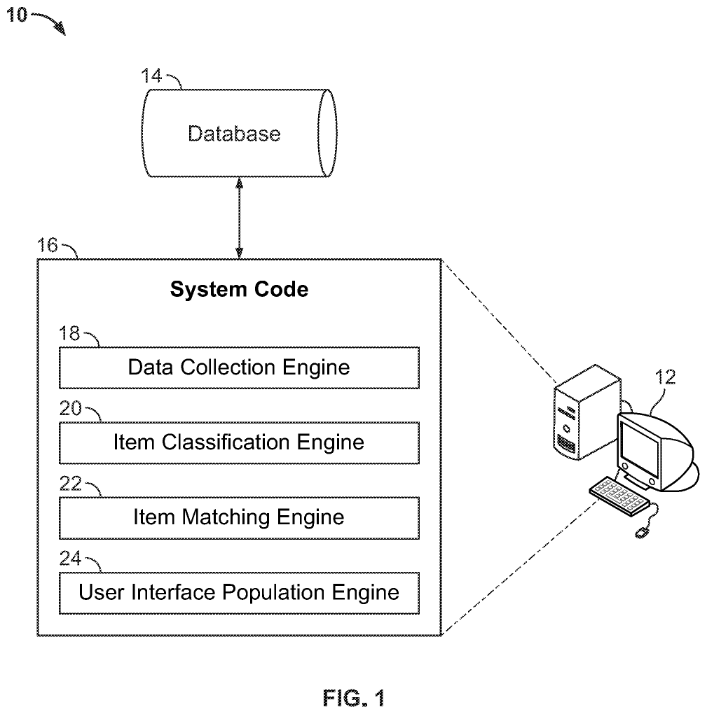

The present disclosure relates to machine learning systems and methods for price list determination from free-form text data, as described in detail below in connection with FIGS. 1-11.

FIG. 1 is a diagram illustrating the system of the present disclosure, indicated generally at 10. The system 10 includes a processor 12 that executes system code (e.g., firmware or software) 16 that provides the specific functions disclosed herein. In particular, the system code 16 includes a data collection engine 18 which collects free-form text data from one or more data sources, such as a database 14 in communication with the system code 16, an item classification engine 20 which processes the text description obtained by the engine 18 using a first machine learning model to classify an item being described by the text description, an item matching engine 22 which processes the text description obtained by the engine 18 using a second machine learning model to identify candidate matching items from a database, and a user interface population engine 24 which processes outputs generated by the engines 20, 22 and automatically populates one or more user interface screens of an insurance claims processing software application based on the output of the engines 20, 22.

The processor 12 could comprise one or more of a personal computer, a server, a smart cellular telephone, a tablet computer, an embedded computing system, a cloud computing service/platform, or any other suitable processor. Additionally, the processor 12 could comprise a customized hardware device such as an application-specific integrated circuit (ASIC), a field-programmable gate array (FPGA), or other suitable hardware device. The system code 16 could communicate with the database 14 over a network connection (e.g., over a local area network (LAN), wide area network (WAN), a wireless network connection, the Internet, etc.). Optionally, the database 14 could be stored on the processor 12. The database 14 stores insurance claims processing information. The system code 16 could be programmed in any suitable high- or low-level programming languages including, but not limited to, C, C++, C#, Java, Python, or any other suitable programming language.

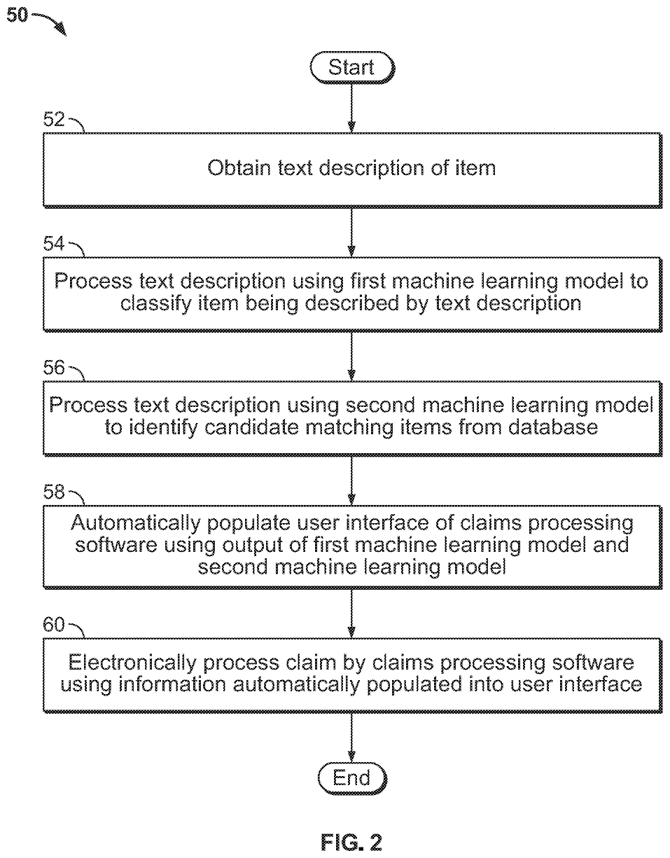

FIG. 2 is a flowchart illustrating steps in accordance with the present disclosure, indicated generally at 50. The processing steps 50 are carried out by the system code 16 of FIG. 1 and its associated software engines 18-22. In step 52, the system obtains a text description of an item from a suitable data source, such as the database 14 of FIG. 1 or from direct text entry by a user in a user interface screen of an insurance claims processing software application, such as the XACTIMATE insurance claims processing software application. The text description can be a free-form text description of an item which does not require any particular text formatting. In step 54, the system processes the text description using a first machine learning model to classify an item being described by the text description. For example, if the free text description is a string of text describing an insurance loss claim relating to a stolen backpack, the first machine learning model processes the free text description to classify the item being described by the text as a backpack. In this step, the system could assign one or more categories and/or sub-categories for the item, which could be tailored for usage with an insurance claims processing software application, such as the XACTIMATE insurance claims processing software application. Advantageously, such automatic classification by machine learning greatly increases the speed and accuracy with which data can be obtained and processed by insurance claims processing software applications.

In step 56, the system processes the text description using a second machine learning model to identify candidate matching items from a database, such as a pricing database that stores a large amount of information relating to replacement items typically involved in insurance claims. For example, if the item described in the free text is classified in step 54 by the first machine learning model as a backpack, the second machine learning model in step 56 could identify one or more replacement backpacks of suitable quality and cost range. In step 58, the system automatically populates one or more user interface screens of the claims processing software (e.g., one or more screens of the XACTIMATE claims processing software) using the outputs of the first and second machine learning models. Advantageously, by automatically populating the user interface screens of the claims processing software, the system greatly increases the speed and accuracy with which the claims processing software can access and process pricing information in connection with claims processing. Finally, in step 60, the claims processing software application processes an insurance claim using the information automatically populated into the user interface by the system.

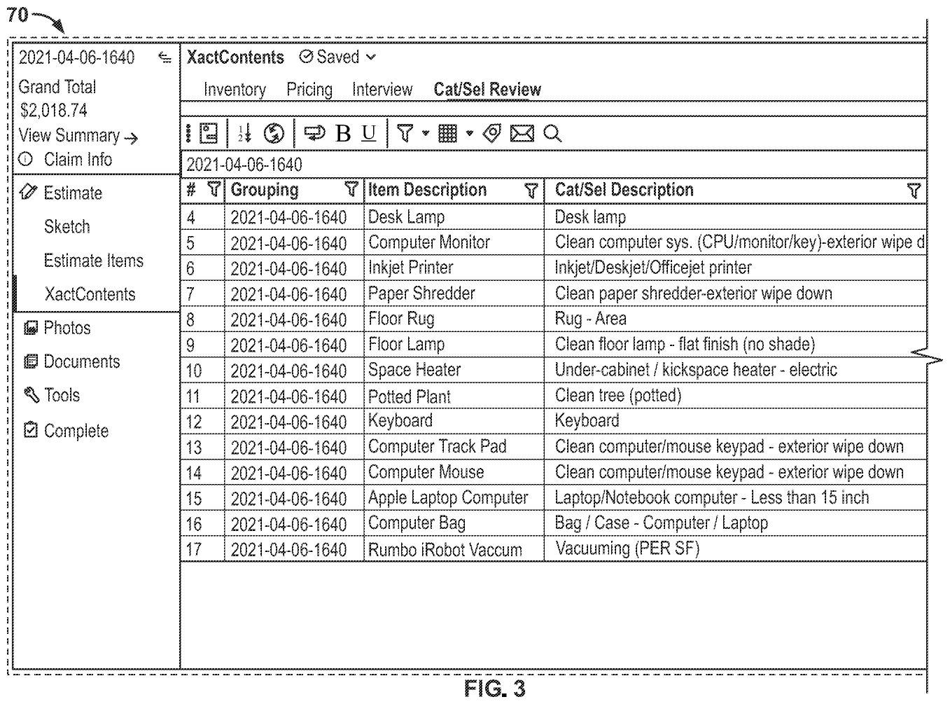

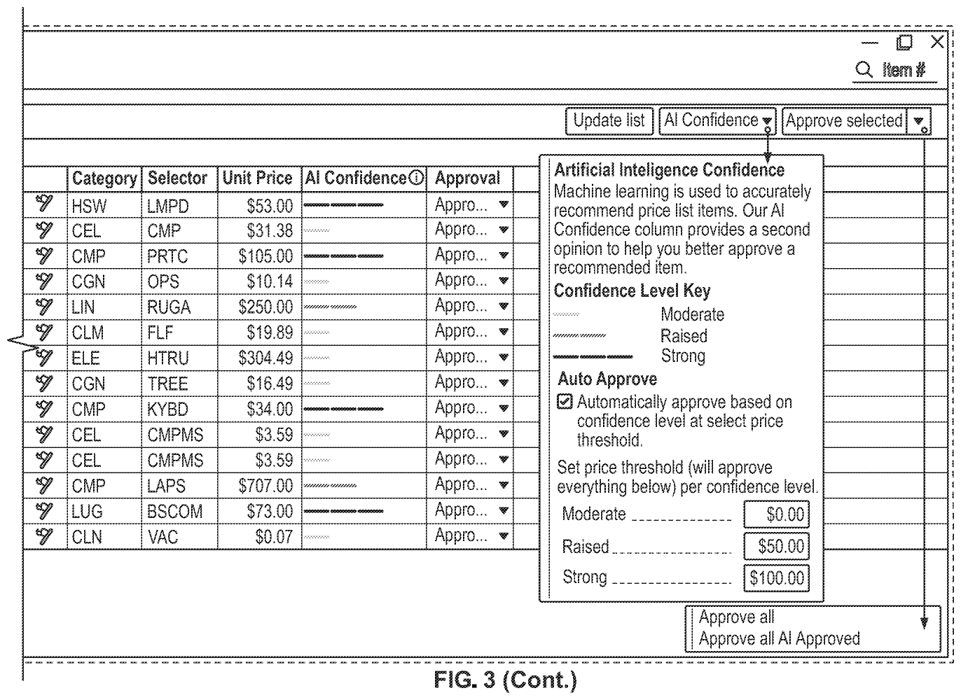

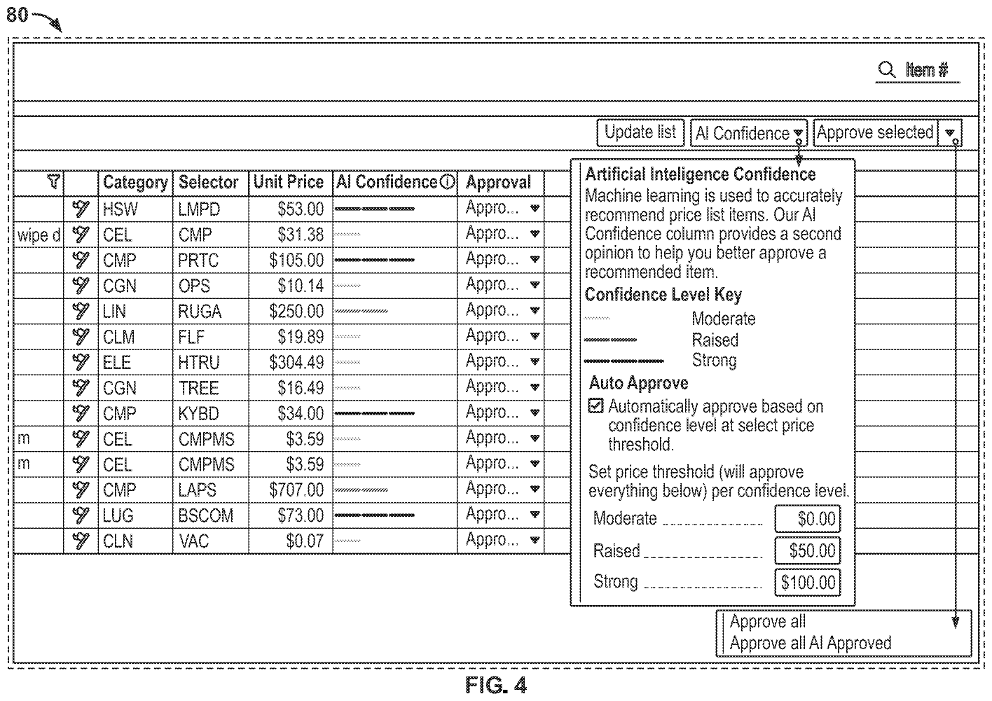

FIGS. 3-10 are screenshots of various user interface screens generated by the system, illustrating operation of the system. As can be seen in FIG. 3, the user interface screen 70 includes a plurality of fields of information relating to an insurance claim to be processed. Such information includes, but is not limited to, grouping codes, item descriptions, cat/sel descriptions, category information, unit prices, and other information. As can be seen in FIG. 4 (which is a zoomed in view of FIG. 3), an artificial intelligence-driven price list screen is displayed to the user, and includes pricing information automatically generated by the system using the machine learning models described in connection with FIGS. 1-2. The screen also provides the user with an indication of the confidence level of the artificial intelligence recommendation, the ability to automatically approve certain recommended items generated by the artificial intelligence features of the system of the present disclosure, and the ability to set price thresholds for such approvals.

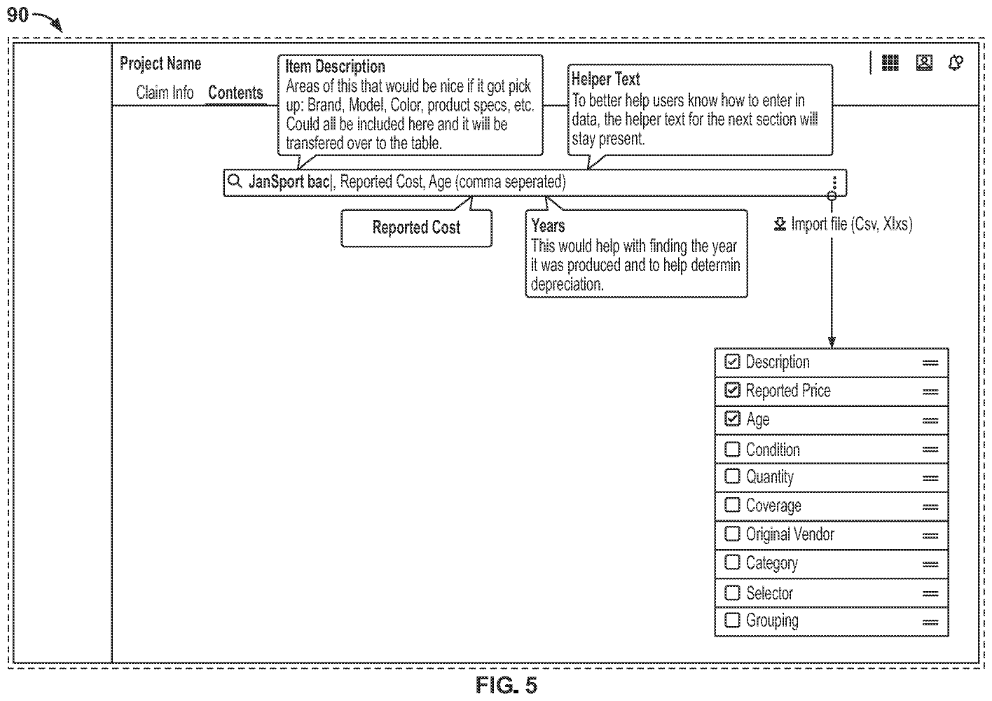

FIG. 5 illustrates a user interface screen 90 which allows the user to enter free-text data describing an item. Such free-text data can include an item description, a reported cost, years during which the item was produced/sold, and additional helper text that can assist processing by the first and second machine learning models described herein. The system can automatically recommend specific types of text such as descriptions, reported prices, ages, conditions, quantities, coverage, original vendor information, category information, selector information, and grouping information.

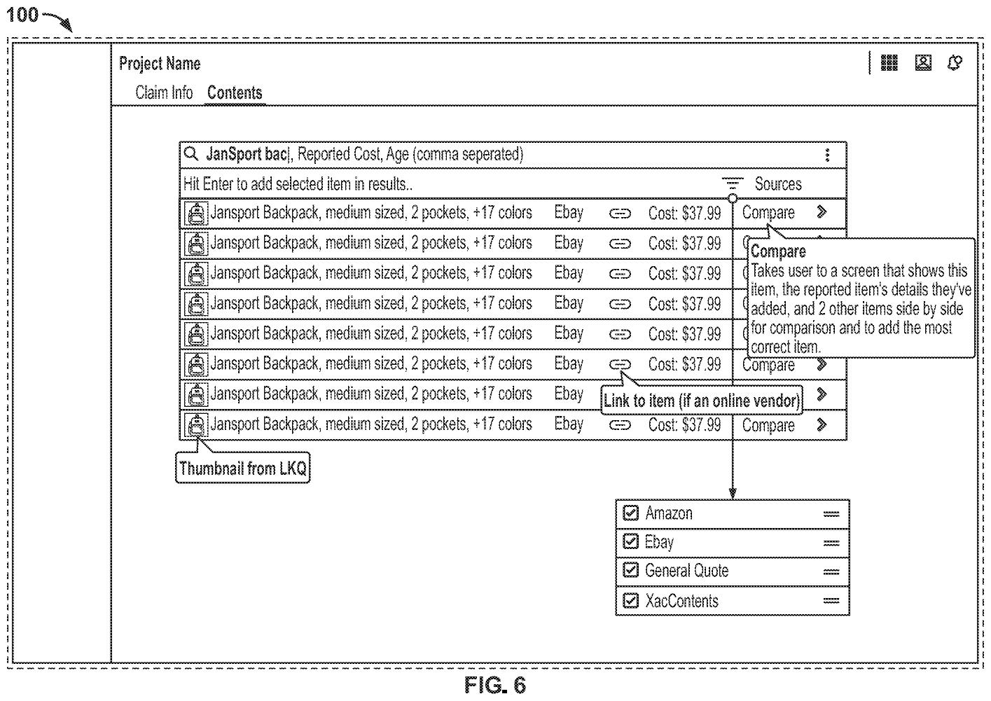

FIG. 6 is a screenshot illustrating price list generation by the system of the present disclosure. When the free text information is entered by the user as illustrated in FIG. 5 discussed above, the first and second machine learning models process the free-form text data to identify a product category and to identify one or more matching items from a pricing database. As can be seen in FIG. 6, the screen 100 displays the results of the machine learning models, which display a list of replacement items (in this case, replacement backpacks) as well as pricing information for the replacement items. By clicking on the “Compare” button, the user can be taken to a screen that shows a particular item, the reported item's details, and other information to allow for a side-by-side comparison of the items and to add the most correct item. As can be appreciated, the system allows for a rapid generation of pricing list information from free-text information using machine learning models.

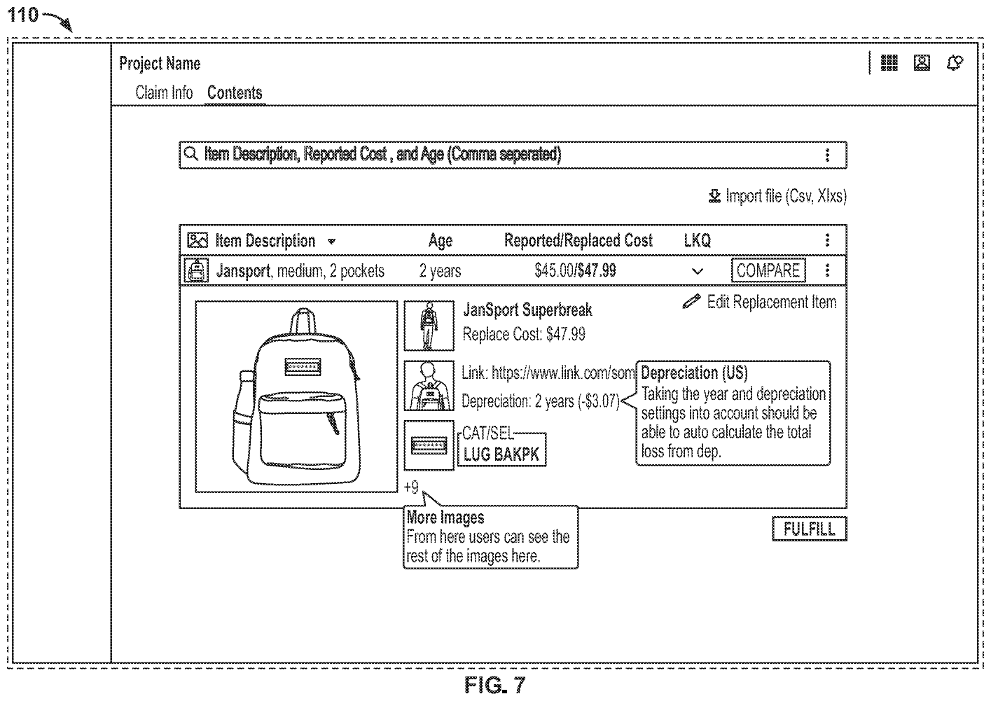

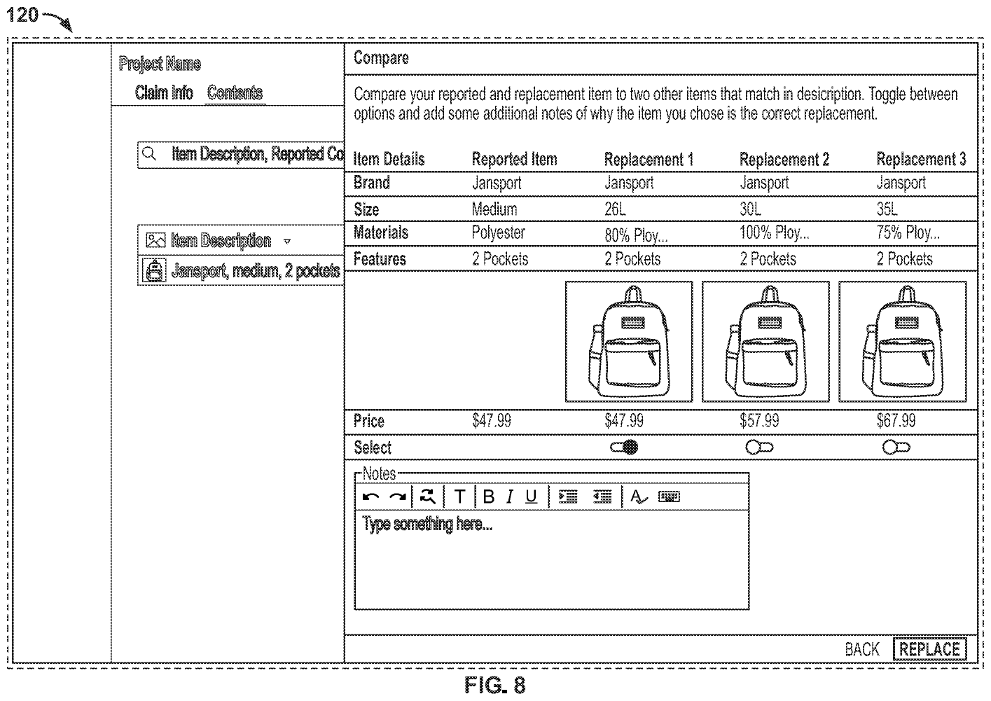

FIG. 7 is screenshot 110 illustrating selection by the user of a desired replacement item from the pricing list of FIG. 6. Detailed information about the item is included, such as a description of the item which takes the year and depreciation into account to calculate a total loss value for the product, and other information. As can be seen in FIG. 8, the system can also generate a screen 120 which allows the user to perform the aforementioned comparison of items in the price list. Comparisons can be performed across brands, sizes, materials, features, prices, and other parameters.

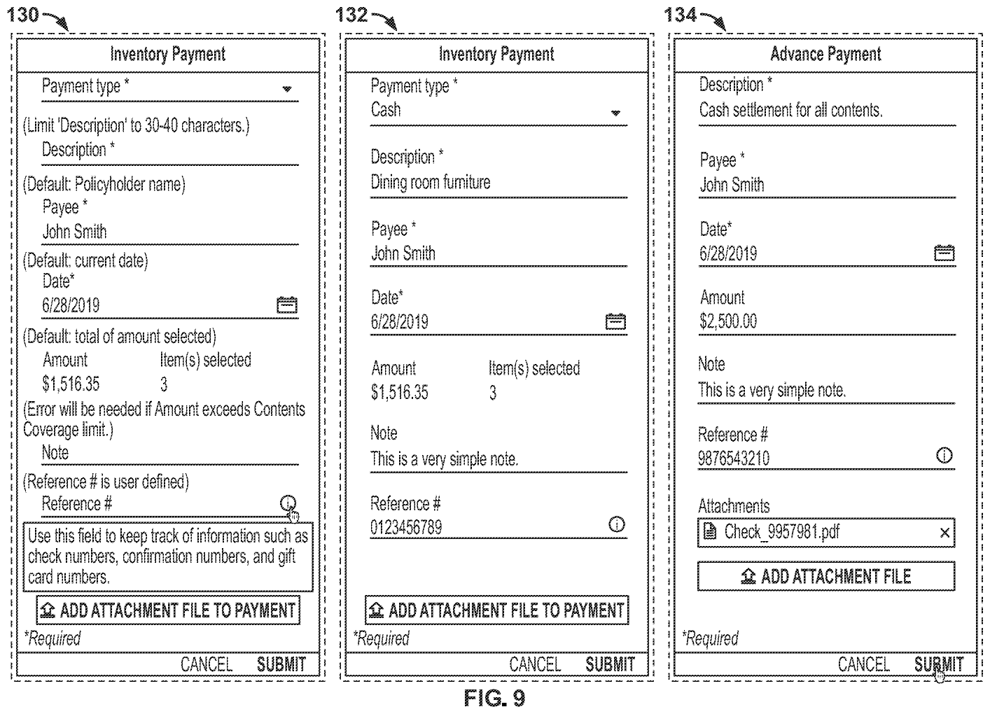

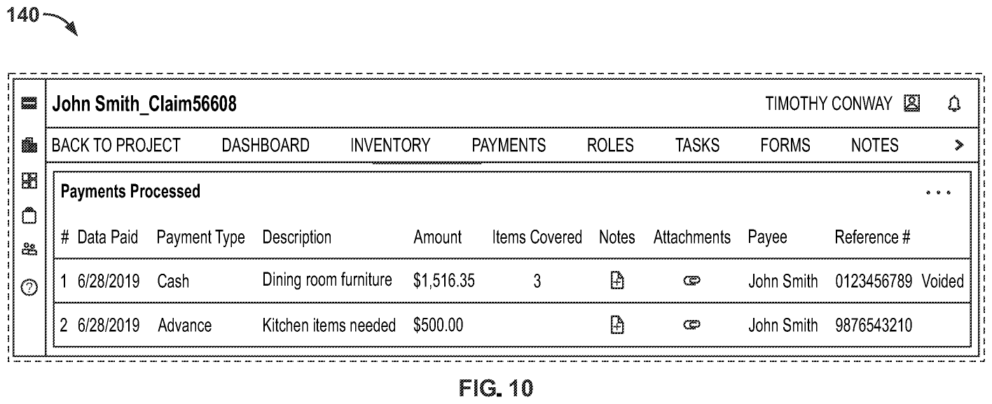

FIG. 9 includes screenshots of user interface screens 130-134 which allow for processing and claims payments after the pricing list information is automatically populated by the system and selected by the user. Using the screens 130-132, the user can enter inventory payment information, and in the screen 134, the user can advance payment to an insurance claimant (e.g., by check). FIG. 10 illustrates a screen 140 which allows the user to track payments and their processing statuses.

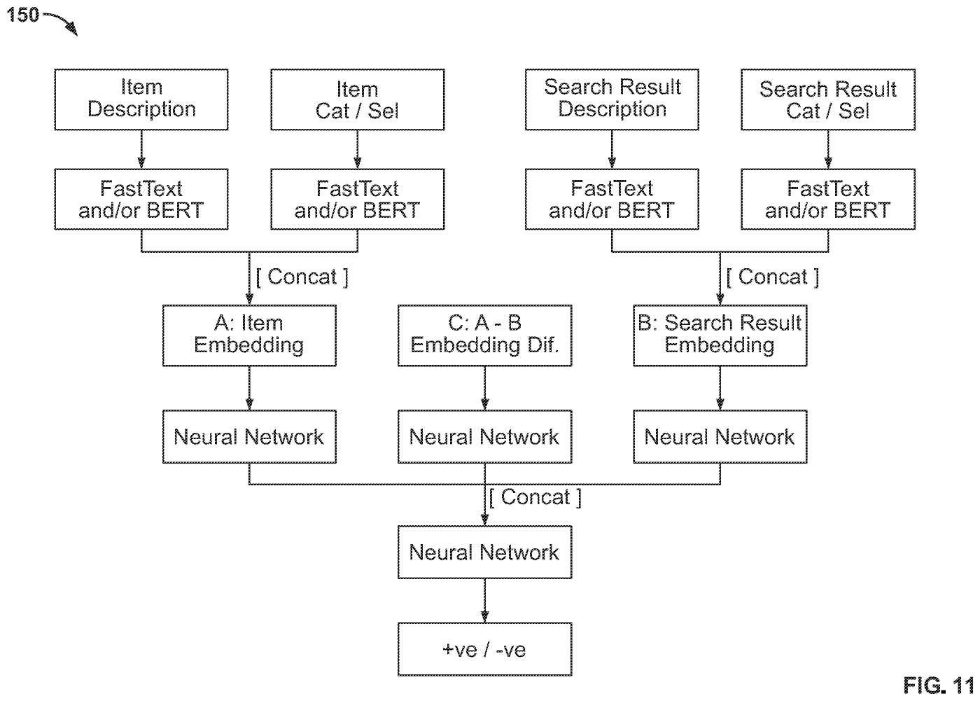

FIG. 11 is a flowchart illustrating, in greater detail, processing steps carried out by the system of the present disclosure, indicated generally at 150. The processing steps illustrated in FIG. 11 comprise an item-matching deep neural network (DNN) model. The item-matching DNN model was built using PyTorch and makes use of FastText (and BERT) embeddings for handling text. FastText embeddings could be used alone, if desired, since they are less computationally intensive and are therefore faster.

Essentially, the DNN model takes in the information of the item in the claim and the information of the items from the database that could potentially be the correct match. The potential correct matches are fetched from the database of items and presorted to a reasonable degree by an existing search API. After the model is fed this information, it outputs a number between 0 and 1 for each of the items returned by the search API. This number is an estimated probability that the item from the search API is the correct item for the filed claim. Because the estimated probability measures the level of confidence that a given item is the correct match, all the potential matches can be sorted in descending order using the estimated probabilities. If the estimated probabilities (and therefore the sorted list of matched items) are perfect, it can be expected that the correct item ranks first and appears in the first location of the sorted list.

Generally, one can assess the relative improvement in the sorting of two lists by computing the normalized discounted cumulative gain (NDCG). However, in the current case, only the location of the correct item (positive matched item) is important, and the relative locations of all the negative items (that should not be selected, and which make up 99 of 100 shortlisted items) is of little interest. As an alternative to NDCG, one could also compare two lists of the items, obtained from two independent sorting methods, by looking at the median location of the correct item (the median location of the item of interest) in the sorted lists.

Overall, the DNN model performed well and reduced the median position of the correct result from 10 down to 2. By making it easy to locate the correct item, this item-matching model and pipeline has the potential to reduce the time required for claims processing by a factor of 5 or by 500%.

Although the foregoing description of the invention is in connection with determination of price lists, it is to be understood that the invention can determine information other than lists, such as pricing data and other types of data.

Having thus described the present disclosure in detail, it is to be understood that the foregoing description is not intended to limit the spirit or scope thereof. What is desired to be protected by Letters Patent is set forth in the following claims.

What is claimed is:

1. A machine learning method for price list determination from free text data, comprising the steps of:
receiving at a processor a text description of an item;
processing the text description using a first machine learning model to classify the item being described by the text description;
processing the text description using a second machine learning model to identify at least one candidate matching item from a database in communication with the processor;
electronically populating a user interface of a claims processing software application using output of the first machine learning model and the second machine learning model; and
electronically processing claims by the claims processing software application using information automatically populated into the user interface by the processor.

2. The method of claim 1, wherein at least one of the first machine learning model or the second machine learning model comprises an item-matching deep neural network (DNN) model executed by the processor.

3. The method of claim 2, wherein the item-matching DNN model includes at least one embedding for processing text information.

4. The method of claim 2, wherein the item-matching DNN model processes the text description and the at least one candidate matching item from the database and outputs a numeric value indicating a probability that the at least one candidate matching item is a correct match.

5. The method of claim 1, further comprising generating a list of matching items, calculating a plurality of probabilities corresponding to the list of matching items, sorting the list of matching items according to the calculated plurality of probabilities, and displaying a sorted list in the user interface of the claims processing software application.

6. The method of claim 5, wherein the list is sorted by computing a normalized discounted cumulative gain.

7. The method of claim 1, wherein the text description of the item is obtained from one or more of an external database or the user interface of the claims processing software.

8. The method of claim 1, wherein the text description comprises a free-form text description of the item and does not require text formatting.

9. The method of claim 1, further comprising assigning by the processor one or more categories or sub-categories for the item tailored for usage with the claims processing software application.

10. The method of claim 1, further comprising displaying on the user interface of the claims processing software application information relating to an insurance claim to be processing and including one or more of a grouping code, an item description, category information, or a unit price.

11. The method of claim 1, further comprising displaying on the user interface of the claims processing software application price list information corresponding to the at least one candidate matching item.

12. The method of claim 1, further comprising displaying on the user interface of the claims processing software application a comparison of the at least one candidate matching item.

13. The method of claim 1, further comprising displaying on the user interface screen of the claims processing software application at least one screen allowing a user to perform one or more of entering inventory payment information, advancing payment to an insurance claimant, or tracking a payment.

14. A machine learning system for price list determination from free text data, comprising:
database storing candidate matching items; and
a processor in communication with the database, the processor programmed to perform the steps of:
receiving at a processor a text description of an item;
processing the text description using a first machine learning model to classify the item being described by the text description;
processing the text description using a second machine learning model to identify at least one candidate matching item from the database;
electronically populating a user interface of a claims processing software application using output of the first machine learning model and the second machine learning model; and
electronically processing claims by the claims processing software using information automatically populated into the user interface by the processor.

15. The system of claim 14, wherein at least one of the first machine learning model or the second machine learning model comprises an item-matching deep neural network (DNN) model executed by the processor.

16. The system of claim 15, wherein the item-matching DNN model includes at least one embedding for processing text information.

17. The system of claim 15, wherein the DNN model processes the text description and the at least one candidate matching item from the database and outputs a numeric value indicating a probability that the at least one candidate matching item is a correct item for inclusion in a claim.

18. The system of claim 14, wherein the processor is further programmed to perform the steps of generating a list of matching items, calculating a plurality of probabilities corresponding to the list of matching items, sorting the list of matching items according to the calculated plurality of probabilities, and displaying a sorted list in the user interface of the claims processing software application.

19. The system of claim 18, wherein the list is sorted by computing a normalized discounted cumulative gain.

20. The system of claim 14, wherein the text description of the item is obtained from one or more of an external database or the user interface of the claims processing software application.

21. The system of claim 14, wherein the text description comprises a free-form text description of the item and does not require text formatting.

22. The system of claim 14, wherein the processor is further programmed to perform the step of assigning by the processor one or more categories or sub-categories for the item tailored for usage with the claims processing software application.

23. The system of claim 14, wherein the processor is further programmed to perform the step of displaying on the user interface of the claims processing software application information relating to an insurance claim to be processing and including one or more of a grouping code, an item description, category information, or a unit price.

24. The system of claim 14, wherein the processor is further programmed to perform the step of displaying on the user interface of the claims processing software application price list information corresponding to the at least one candidate matching item.

25. The system of claim 14, wherein the processor is further programmed to perform the step of displaying on the user interface of the claims processing software application a comparison of the at least one candidate matching item.

26. The system of claim 14, wherein the processor is further programmed to perform the step of displaying on the user interface screen of the claims processing software application at least one screen allowing a user to perform one or more of entering inventory payment information, advancing payment to an insurance claimant, or tracking a payment.
